(19) United States
(12) Patent Application Publication
(10) Pub. No.: US 2025/0285259 A1
(43) Pub. Date: Sep. 11, 2025

(54) ARTICLE INSPECTION APPARATUS

(71) Applicant: ANRITSU CORPORATION, Kanagawa (JP)

(72) Inventors: Takeshi YAMAZAKI, Kanagawa (JP); Lawrence Earl CARANDANG, Kanagawa (JP)

(21) Appl. No.: 19/073,868

(22) Filed: Mar. 7, 2025

(30) Foreign Application Priority Data
Mar. 11, 2024 (JP) 2024-037071

(51) Int. Cl. G06T 7/00; G06V 10/764

(52) U.S. Cl. CPC G06T 7/0006; G06V 10/765; G06T 2207/10024; G06T 2207/10048; G06T 2207/10116; G06T 2207/20081

(57) ABSTRACT

Provided is an article inspection apparatus that improves inspection accuracy. An AI processing unit outputs determination data indicating a quality of an article captured in a captured image using a learning model that has been trained with an image, and a rule-based processing unit outputs determination data indicating the quality of the article captured in the captured image using an image processing unit that performs image processing on the captured image. A comprehensive determination unit performs comprehensive determination of the quality of the article captured in the captured image based on both the determination data output from the AI processing unit and the rule-based processing unit.

### TECHNICAL FIELD

The present invention relates to an article inspection apparatus.

### BACKGROUND ART

As an article inspection apparatus that determines a quality state of an article, for example, apparatuses disclosed in Patent Document 1 and Patent Document 2 have been proposed. The article inspection apparatus disclosed in Patent Document 1 is an apparatus that detects a foreign substance by performing image processing of combining an image processing filter with an X-ray image (captured image) that indicates an amount of X-ray transmission detected by irradiating the article with X-rays. However, in the article inspection apparatus of Patent Document 1, there is a concern that a foreign substance having characteristics similar to those of the article cannot be detected.

In addition, in the article inspection apparatus disclosed in Patent Document 2, the X-ray image of the article is input to a learning model to inspect the quality state. The article inspection apparatus of Patent Document 2 is capable of accurately detecting defects such as foreign substances or flaws that have been trained, but there is a concern that unpredictable foreign substances or flaws that have not been trained may be erroneously detected.

### RELATED ART DOCUMENT

### Patent Document

[Patent Document 1] JP-A-2012-137387
[Patent Document 2] JP-A-2023-114828

### DISCLOSURE OF THE INVENTION

### Problem that the Invention is to Solve

The present invention has been made in view of the above circumstances, and an object thereof is to provide an article inspection apparatus that improves inspection accuracy.

### Means for Solving the Problem

In order to achieve the above-described object, according to a first aspect of the present invention, there is provided an article inspection apparatus that inspects an article based on a captured image, the article inspection apparatus including an image storage unit that stores the captured image of the article captured by an imaging unit, an AI processing unit that outputs first determination data indicating a quality state of the article captured in the captured image using a learning model that has been trained with an image in advance, a rule-based processing unit that performs image processing on the captured image using a predetermined image processing algorithm and outputs second determination data indicating the quality state of the article captured in the captured image, and a comprehensive determination unit that performs comprehensive determination of the quality state of the article captured in the captured image based on the first determination data and the second determination data.

With this configuration, the article inspection apparatus according to the first aspect of the present invention can enable the rule-based processing unit and the AI processing unit to complement each other's poor accurate portions, and can improve the inspection accuracy.

According to a second aspect of the present invention, in the article inspection apparatus according to the first aspect of the present invention, in a case where the first determination data and/or the second determination data includes a defect in the quality state of the article, position information of a defective portion in the captured image is further included.

With this configuration, the article inspection apparatus according to the second aspect of the present invention can detect a position of the defective portion in the captured image.

According to a third aspect of the present invention, in the article inspection apparatus according to the first aspect of the present invention, the article inspection apparatus further includes a determination rule setting unit that sets a rule for determination of the comprehensive determination unit, in which the comprehensive determination unit performs the comprehensive determination of the quality state in accordance with the set rule. In addition, according to a fourth aspect of the present invention, in the article inspection apparatus according to the second aspect of the present invention, the article inspection apparatus further includes a determination rule setting unit that sets a rule for determination of the comprehensive determination unit, in which the comprehensive determination unit performs the comprehensive determination of the quality state in accordance with the set rule.

With this configuration, the article inspection apparatuses according to the third aspect and the fourth aspect of the present invention can set a rule in accordance with the type of the article, the accuracy of the rule-based processing unit, and the accuracy of the AI processing unit, and further improve the inspection accuracy.

According to a fifth aspect of the present invention, in the article inspection apparatus according to the first aspect of the present invention, the first determination data and the second determination data each indicate a defect degree for each position of the captured image, and the comprehensive determination unit synthesizes the first determination data output from the AI processing unit and the second determination data output from the rule-based processing unit, and performs the comprehensive determination of the quality state of the article from a synthesis result. In addition, according to a sixth aspect of the present invention, in the article inspection apparatus according to the second aspect of the present invention, the first determination data and the second determination data each indicate a defect degree for each position of the captured image, and the comprehensive determination unit synthesizes the first determination data output from the AI processing unit and the second determination data output from the rule-based processing unit, and performs the comprehensive determination of the quality state of the article from a synthesis result. In addition, according to a seventh aspect of the present invention, in the article inspection apparatus according to the third aspect of the present invention, the first determination data and the second determination data each indicate a defect degree for each position of the captured image, and the comprehensive determination unit synthesizes the first determination data output from the AI processing unit and the second determination data output from the rule-based processing unit, and performs the comprehensive determination of the quality state of the article from a synthesis result.

With this configuration, the article inspection apparatuses according to the fifth to seventh aspects of the present invention synthesize the second determination data of the rule-based processing unit and the first determination data of the AI processing unit. As a result, it is possible to further improve the inspection accuracy.

According to an eighth aspect of the present invention, in the article inspection apparatus according to the first aspect of the present invention, in a case where a first defective portion is included in the first determination data and a second defective portion different from the first defective portion is included in the second determination data, the comprehensive determination unit determines that both the first defective portion and the second defective portion are defective portions of the article. In addition, according to a ninth aspect of the present invention, in the article inspection apparatus according to the second aspect of the present invention, in a case where a first defective portion is included in the first determination data and a second defective portion different from the first defective portion is included in the second determination data, the comprehensive determination unit determines that both the first defective portion and the second defective portion are defective portions of the article. In addition, according to a tenth aspect of the present invention, in the article inspection apparatus according to the third aspect of the present invention, in a case where a first defective portion is included in the first determination data and a second defective portion different from the first defective portion is included in the second determination data, the comprehensive determination unit determines that both the first defective portion and the second defective portion are defective portions of the article.

With this configuration, in the article inspection apparatuses according to the eighth to tenth aspects of the present invention, both of the AI processing unit and the rule-based processing unit determine a portion, which is determined as a defective portion only by one of the AI processing unit and the rule-based processing unit, as a defective portion of the article, thereby further improving the inspection accuracy.

According to an eleventh aspect of the present invention, in the article inspection apparatus according to the first aspect of the present invention, the AI processing unit outputs the first determination data using a plurality of the learning models. In addition, according to a twelfth aspect of the present invention, in the article inspection apparatus according to the second aspect of the present invention, the AI processing unit outputs the first determination data using a plurality of the learning models.

With this configuration, in the article inspection apparatuses according to the eleventh and twelfth aspects of the present invention, the AI processing unit outputs the first determination data using the plurality of learning models. As a result, it is possible to further improve the inspection accuracy.

According to a thirteenth aspect of the present invention, in the article inspection apparatus according to the first aspect of the present invention, the rule-based processing unit performs the image processing on the captured image using a plurality of the image processing algorithms, and outputs the second determination data based on an image processing result of each image processing algorithm. In addition, according to a fourteen aspect of the present invention, in the article inspection apparatus according to the second aspect of the present invention, the rule-based processing unit performs the image processing on the captured image using a plurality of the image processing algorithms, and outputs the second determination data based on an image processing result of each image processing algorithm.

With this configuration, in the article inspection apparatuses according to the thirteenth aspect and the fourteenth aspect of the present invention, the rule-based processing unit performs image processing using the plurality of the image processing algorithms, and outputs the second determination data based on the image processing result of each image processing algorithm. As a result, it is possible to further improve the inspection accuracy.

### Advantage of the Invention

With the article inspection apparatus according to the present invention, an effect of improving inspection accuracy is achieved.

The present invention has been briefly described above. Further, the details of the present invention will be further clarified by reading through a mode for carrying out the invention described below (hereinafter referred to as an “embodiment”) with reference to the accompanying drawings.

### BRIEF DESCRIPTION OF THE DRAWINGS

FIG. 1 is a block diagram of an article inspection apparatus according to a first embodiment of the present invention.

FIG. 2 is an explanatory diagram for describing an AND determination performed by a comprehensive determination unit shown in FIG. 1.

FIG. 3 is an explanatory diagram for describing an OR determination performed by the comprehensive determination unit shown in FIG. 1.

FIG. 4 is an explanatory diagram for describing a synthesis determination performed by the comprehensive determination unit shown in FIG. 1.

FIG. 5 is an explanatory diagram for describing a synthesis determination performed by the comprehensive determination unit shown in FIG. 1.

FIG. 6 is an explanatory diagram for describing a synthesis determination performed by the comprehensive determination unit shown in FIG. 1.

FIG. 7 is a block diagram of an article inspection apparatus according to a second embodiment of the present invention.

### BEST MODE FOR CARRYING OUT THE INVENTION

Specific embodiments of the present invention will be described below with reference to the respective figures.

### First Embodiment

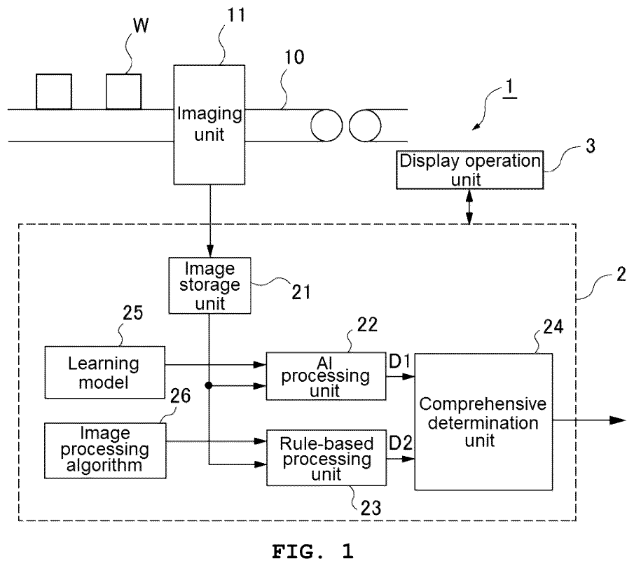

First, an article inspection apparatus 1 according to the first embodiment will be described. The article inspection apparatus 1 shown in FIG. 1 is an apparatus that inspects a quality (quality state) of an article W transported by a transport belt 10.

As shown in FIG. 1, the article inspection apparatus 1 includes a control unit 2 and a display operation unit 3. The control unit 2 is composed of a computer that integrally controls each unit in order to inspect the article W. The control unit 2 includes an image storage unit 21, an AI processing unit 22, a rule-based processing unit 23, and a comprehensive determination unit 24. The image storage unit 21 stores the captured image of the article W captured by an imaging unit 11.

The imaging unit 11 sequentially images the articles W that are sequentially transported by the transport belt 10. As the captured image, a color image, a black and white image, an X-ray image, an infrared image, or the like is considered, and the captured image is captured by a camera corresponding to the captured image (for example, a camera that captures an appearance image of the article W, an X-ray camera that captures a transmission image of the article W, a near-infrared camera that captures the appearance image or the transmission image).

The AI processing unit 22 outputs determination data D1 that indicates the quality of the article W by using a learning model 25 that has been trained with the image. In the present embodiment, the learning model 25 is a learning model generated by machine learning using an image of a good product of the article W and an image obtained by imaging defective portions such as foreign substances or flaws. The AI processing unit 22 acquires the defect degree for each pixel (position) of the captured image as the output of the result of applying the learning model 25 to the captured image of the article W, and in a case where there is a pixel having the defect degree equal to or greater than a determination value, outputs the determination data D1 that indicates that the pixel (position) is a defective portion.

The rule-based processing unit 23 does not use the learning model 25, but performs image processing using a predetermined image processing algorithm 26 that indicates a procedure such as analysis processing using a difference in value relative to the surroundings, frequency analysis, and pattern matching, to perform image processing on the input captured image, and outputs determination data D2 based on the result of the image processing. The image processing using the image processing algorithm 26 is composed of an image processing filter. In the present embodiment, a filter that is capable of extracting a defective portion in the captured image is employed as the image processing filter. In the image processing result image which has been subjected to the image processing, a gradation (density, brightness, chromaticity, and the like) increases as the defect degree of the pixel of the defective portion becomes higher. In a case where there is a pixel having a gradation (=defect degree) equal to or greater than a threshold value for defect determination in the image processing result image subjected to the image processing, the rule-based processing unit 23 outputs the determination data D2 that indicates that the pixel (position) is a defective portion.

The comprehensive determination unit 24 performs comprehensive determination of a quality of the article W captured in the captured image based on the determination data D1 and D2 output from the AI processing unit 22 and the rule-based processing unit 23. In the present embodiment, the comprehensive determination unit 24 determines that a pixel, which has been determined to be a defective portion by both the AI processing unit 22 and the rule-based processing unit 23, is a defective portion (referred to as “AND determination”).

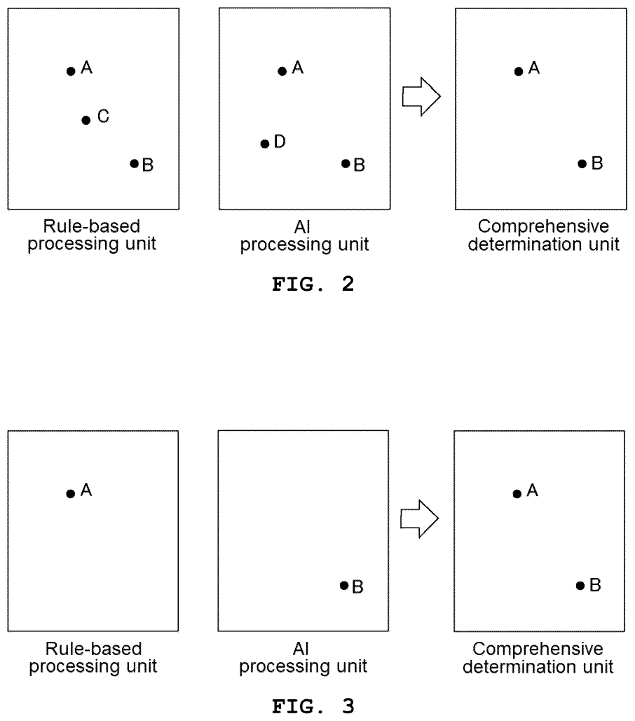

For example, as shown in FIG. 2, in a case where the rule-based processing unit 23 determines that pixels A, C, and B in the captured image are the defective portions and the AI processing unit 22 determines that pixels A, B, and D in the captured image are the defective portions, the comprehensive determination unit 24 comprehensively determines that the pixels A and B, which have been determined to be the defective portions by both the rule-based processing unit 23 and the AI processing unit 22, are the defective portions. The comprehensive determination unit 24 does not determine that the pixel B, which has been determined as the defective portion only by the rule-based processing unit 23, or the pixel D which has been determined as the defective portion only by the AI processing unit 22, is the defective portion.

According to the above-described embodiment, the comprehensive determination unit 24 performs comprehensive determination of the quality of the article W based on the determination data D1 and D2 from the AI processing unit 22 and the rule-based processing unit 23. As a result, the AI processing unit 22 and the rule-based processing unit 23 are capable of complementing each other's poor accurate portions, and the inspection accuracy can be improved.

To describe in detail, the AI processing unit 22 may erroneously detect an unexpected portion (pixel D in FIG. 2) as a defective portion depending on the learned contents. Depending on the type of the image processing filter, the rule-based processing unit 23 may erroneously detect the article W (good product) (pixel C) having a shape, color, or the like close to the defective portion as the defective portion. The comprehensive determination unit 24 determines that a portion, which has been determined to be a defective portion by both the AI processing unit 22 and the rule-based processing unit 23, is a defective portion. As a result, it is possible to further reduce the erroneous detection and improve the inspection accuracy.

According to the first embodiment described above, the comprehensive determination unit 24 performs the AND determination on the determination data D1 and D2 of the AI processing unit 22 and the rule-based processing unit 23, but the present invention is not limited thereto. The comprehensive determination unit 24 may determine that a portion, which has been determined to be a defective portion by at least one of the AI processing unit 22 or the rule-based processing unit 23, is a defective portion (referred to as “OR determination”).

For example, as shown in FIG. 3, in a case where the rule-based processing unit 23 determines that the pixel A in the captured image is a defective portion (also referred to as a second defective portion) and the AI processing unit 22 determines that the pixel B in the captured image is a defective portion (also referred to as a first defective portion), the comprehensive determination unit 24 comprehensively determines that both the pixels A and B, which have been determined to be defective portions by at least one of the rule-based processing unit 23 or the AI processing unit 22, are defective portions.

To describe in detail, the AI processing unit 22 may not be able to detect an unexpected defective portion (pixel A in FIG. 3) defective portion depending on the learned contents. Depending on the type of the image processing filter, the rule-based processing unit 23 may not be able to detect a defective portion (pixel B) close to the shape of the article W (good product) as the defective portion. The comprehensive determination unit 24 determines that a portion, which has been determined to be a defective portion by at least one of the AI processing unit 22 or the rule-based processing unit 23, is a defective portion. Accordingly, it is possible to improve the inspection accuracy.

For example, a case where, in the rule-based processing unit 23, X-ray images of two different energy bands are used as the captured image input and a dual-energy subtraction image in which product influence is reduced and the foreign substance is emphasized is employed in the image processing will be considered. In the dual-energy subtraction image, a difference in transmittance of X-rays in the foreign substance in the X-rays is used to attenuate contrast due to unevenness of the product, and contrast due to the foreign substance is emphasized, so that it is possible to easily detect a foreign substance captured with a low contrast, such as a bone. In addition, a soft foreign substance such as a resin having an X-ray transmittance close to that of the article W is difficult to detect because the influence of the soft foreign substance is attenuated in the dual-energy subtraction image as in the article W.

On the other hand, the AI processing unit 22 that has learned the X-ray image may be inferior to the rule-based processing unit 23 that uses the dual-energy subtraction image in the detection of a bone captured with a low contrast, but the AI processing unit 22 may be able to detect the soft foreign substance such as resin that is difficult to detect with the rule-based processing unit 23 without erroneous detection. In such a case, it is possible to improve the inspection accuracy by adopting the above-described OR determination.

In addition, it is also conceivable that the comprehensive determination unit 24 synthesizes the output of the learning model 25 and the output of the image processing by means of the image processing algorithm 26, and based on the comparison between the result and a determination value, performs the comprehensive determination (synthesis determination). The AI processing unit 22 outputs the output of the learning model 25, that is, the defect degree for each pixel of the captured image, as the determination data D1. The rule-based processing unit 23 outputs the output of the image processing unit 26, that is, the gradation for each pixel of the image processing result image after the image processing, as the determination data D2.

The comprehensive determination unit 24 calculates a synthetic value from the defect degree for each pixel of the captured image output from the AI processing unit 22 and the gradation for each pixel of the image processing result image output from the rule-based processing unit 23. In general, the defect degree is set in a range of 0 to 1, and the gradation is set in a range of 0 to, for example, 256. Therefore, it is considered to multiply the defect degree by a coefficient so that the defect degree matches the gradation, and to calculate a synthetic value by adding the defect degree multiplied by the coefficient and the gradation. The comprehensive determination unit 24 comprehensively determines a pixel whose synthetic value is equal to or greater than the threshold value for synthetic value determination, as a defective portion.

As a method of calculating the synthetic value, in addition to the above, it is also possible to multiply both the defect degree and the gradation by a coefficient calculated using a certain value or a function related to a pixel (position), to perform multiplication instead of addition, or to take the square root of the multiplication result.

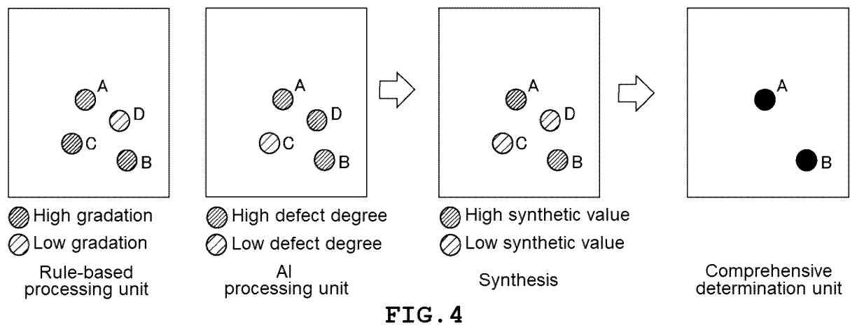

For example, as shown in FIG. 4, the rule-based processing unit 23 outputs the same gradation in the pixels A, B, and C of the captured image and a gradation lower than the gradations of the pixels A, B, and C in the pixel D, as the determination data D2. The AI processing unit 22 outputs the same defect degree in the pixels A, B, and D of the captured image and a defect degree lower than the defect degrees of the pixels A, B, and D in the pixel C, as the determination data D1. In this case, in a case where the determination data D1 and D2 are synthesized as described above, the synthetic value of the pixels A and B is equal to or greater than the threshold value for synthetic value determination, and the comprehensive determination unit 24 comprehensively determines that the pixels A and B are the defective portions. The comprehensive determination unit 24 does not determine that the synthetic value of the pixels C and D are less than the threshold value for the synthetic value determination and the pixels C and D are defective portions.

To describe in detail, the AI processing unit 22 may erroneously detect an unexpected portion (pixels C and D in FIG. 4) as a defective portion depending on the learned contents. The AI processing unit 22 alone can prevent erroneous detection of the pixel C by setting the determination value, but cannot prevent erroneous detection of the pixel D. In addition, the rule-based processing unit 23 may erroneously detect the article W (good product) (pixels C and D in FIG. 4) having a shape, color, or the like close to the defective portion as the defective portion. The rule-based processing unit 23 alone can prevent erroneous detection of the pixel D by setting the threshold value for the defect determination, but cannot prevent erroneous detection of the pixel C. However, by synthesizing the determination data D1 and D2, it is possible to reduce the possibility that the pixels C and D, which are not defective portions, are erroneously detected as defective portions.

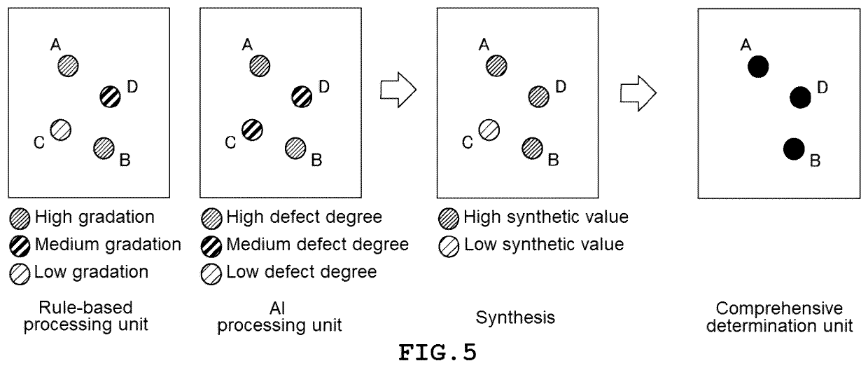

In addition, as another example, as shown in FIG. 5, the rule-based processing unit 23 outputs an image processing result indicating that the pixels A and B of the image processing result image have a high gradation, the pixel D has a medium gradation, and the pixel C has a low gradation, as the determination data D2. The AI processing unit 22 outputs a result of the defect degree indicating that the pixels A and B of the captured image have a high defect degree and the pixels C and D have a medium defect degree, as the determination data D1. In this case, in a case where the comprehensive determination unit 24 synthesizes the determination data D1 and D2, the synthetic value of the pixels A, B, and D becomes equal to or greater than the threshold value for the synthetic value, the comprehensive determination unit 24 comprehensively determines that the pixels A, B, and D are defective portions, the synthetic value of the pixel C becomes less than the threshold value for the synthetic value, and the comprehensive determination unit 24 does not determine that the pixel C is a defective portion.

In this example, the pixel D having a medium gradation is not determined as the defective portion only by the rule-based processing unit 23, and the pixels C and D having a medium defect degree are not determined as the defective portions only by the AI processing unit 22. However, since the pixel D having medium values in both processing is highly likely to be a defective portion, the comprehensive determination unit 24 is capable of comprehensively determining the pixel D as a defective portion.

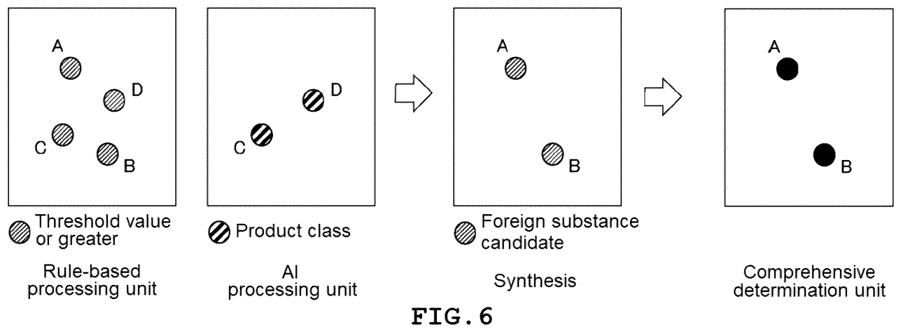

In addition, as another synthesis determination example, the comprehensive determination unit 24 can prioritize the detection of the good product by either the rule-based processing unit 23 or the AI processing unit 22, and in a case where the defective product is detected by the other, consider the detection as erroneous detection and exclude it from the defective product result. Specifically, as shown in FIG. 6, the rule-based processing unit 23 outputs an image processing result in which the pixels A to D of the image processing result image have a gradation higher than the threshold value for the defect determination, as the determination data D2. The AI processing unit 22 uses product class detection using the learning model 25 here, detects product classes in the pixels C and D of the captured image, and outputs a result in which the product class is not detected in the pixels A and B as the determination data D1. In this case, in a case where the comprehensive determination unit 24 synthesizes the determination data D1 and D2, the pixels C and D are excluded as being erroneous detections because the product class is detected by the AI processing unit 22, the pixels A and B for which the AI processing unit 22 does not detect the product class are candidates for the foreign substance, and the comprehensive determination unit 24 determines that the pixels A and B are defective portions and does not determine that the pixels C and D are defective portions.

This example involves processing in which a portion detected by the rule-based processing unit 23 (portion exceeding the threshold value) is treated as an erroneous detection due to the influence of, for example, unevenness of the product that is difficult to distinguish from a foreign substance, and is treated as an exclusion target. Conversely, in a case where a portion that is a good product in the rule-based processing unit 23 is detected as a defective portion by the AI processing unit 22, the defective portion may be treated as an erroneous detection and may be treated as an exclusion target. In addition, in addition to the exclusion of the erroneous detection based on the product class, the foreign substance candidate may be narrowed down by synthesizing the gradation value of the rule-based processing and the defect degree of the foreign substance class. In addition, the comprehensive determination may be performed such that the rule-based processing unit 23 and the AI processing unit 22 each output the quality determination result, and the comprehensive determination unit 24 logically denies one (good product detection priority side) and then performs the AND processing to determine the presence or absence of the defect.

As described above, according to the present embodiment, the determination data D1 and D2 of the AI processing unit 22 and the rule-based processing unit 23 are synthesized, and the comprehensive determination of the quality of the article W is performed based on the result. Therefore, it is possible to reduce the number of pixels that are not defective portions being erroneously detected as a defective portion, and to determine that a defective portion that is determined to be a barely good product by both the AI processing unit 22 and the rule-based processing unit 23 is a defective portion, and it is possible to further improve the detection accuracy.

The determination rules of the comprehensive determination unit 24 may be various, such as AND determination, OR determination, and synthesis determination. Which determination is optimal varies depending on the type of the article W, the learned contents of the learning model 25, and the like. Therefore, it is also considered that a determination rule setting area (determination rule setting unit) for setting a determination rule of the comprehensive determination unit 24 is displayed on the display operation unit 3 consisting of a touch panel, and the comprehensive determination unit 24 performs the comprehensive determination in accordance with the rule set by the operation of the determination rule setting area. As a result, it is possible to set the rule of the comprehensive determination in accordance with the type of the article W and the accuracy of the AI processing unit 22 and the rule-based processing unit 23, and it is possible to further improve the inspection accuracy.

In the determination rule setting area, a selection screen of the AND determination, the OR determination, and the synthesis determination is displayed, and the comprehensive determination unit 24 performs the determination in accordance with the selected determination rule. In addition, it is also considered that a selection screen for selecting the type of the article W is displayed in the determination rule setting area, and the comprehensive determination unit 24 performs the determination in accordance with the determination rule corresponding to the selected type.

In addition, in the present embodiment, the comprehensive determination unit 24 performs the comprehensive determination based on the presence or absence of the defective portion and the defect degree for each pixel included in the determination data D1 and D2 according to the determination rule, and the determination data D1 and D2 include a position of the pixel of the captured image to be determined as position information.

In a case where there is an area (blob) that is likely to be a defective portion in the AI processing unit 22 or the rule-based processing unit 23, the comprehensive determination unit 24 may perform the comprehensive determination on the area (referred to as a defective candidate area) in addition to the determination for each pixel of the captured image. For example, in a case where there is a defective candidate area in the AI processing unit 22, position information thereof (the defective candidate area, coordinates of each vertex of the circumscribed quadrilateral of the defective candidate area, or the like) is output from the AI processing unit 22 as the determination data D1, in a case where there is a defective candidate area in the rule-based processing unit 23, the position information thereof is output from the rule-based processing unit 23 as the determination data D2, and the comprehensive determination is performed based on the determination data D1 and D2 (for example, in a case where there are defective candidate coordinates in any of the determination data D1 and D2, it is determined that there is a defective portion). Further, in addition to the position information, the determination data D1 may include the defect degree for each pixel in the area indicated by the position information and the determination data D2 may include the gradation for each pixel of the captured image in the area indicated by the position information, and the quality of the article W may be comprehensively determined based on the position information and the defect degree or the gradation corresponding to the position information. In this way, it becomes possible to make a determination in consideration of the size of a defective portion such as foreign substances or flaws.

### Second Embodiment

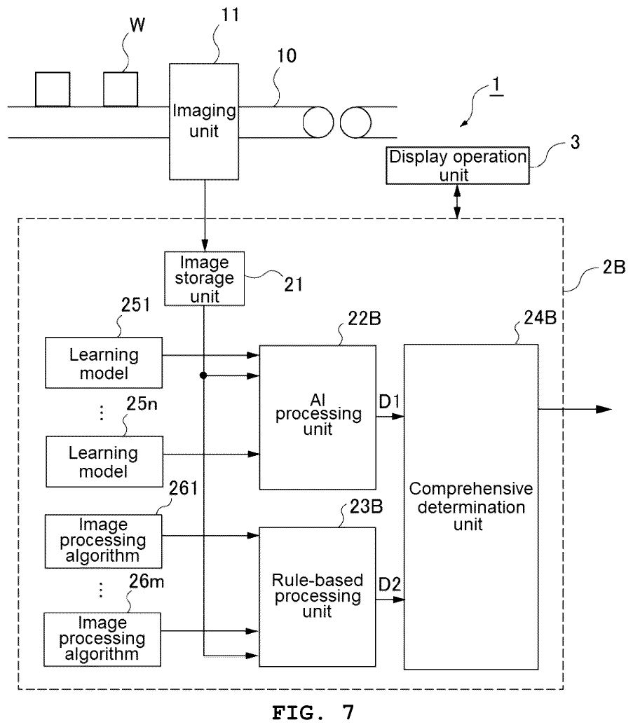

Next, an article inspection apparatus 1B of the second embodiment will be described with reference to FIG. 7. In FIG. 5, the same parts as those of the article inspection apparatus 1 according to the first embodiment described above are denoted by the same reference numerals, and the detailed description thereof will be omitted.

As shown in FIG. 7, the article inspection apparatus 1B includes a control unit 2B and the display operation unit 3. The control unit 2B is composed of a computer that integrally controls each unit in order to inspect the article W. The control unit 2B includes the image storage unit 21, an AI processing unit 22B, a rule-based processing unit 23B, and a comprehensive determination unit 24B.

A difference between the AI processing unit 22 of the first embodiment and the AI processing unit 22B of the second embodiment is that a plurality of learning models 251 to 25n (n is any integer) are provided. The learning models 251 to 25n differ from each other in learned contents and model structure. The AI processing unit 22B may output determination data D1 based on the output from all of the learning models 251 to 25n. In addition, the AI processing unit 22B may output the determination data D1 based on the output of the learning models 251 to 25n selected by the operation of the display operation unit 3 or the learning models 251 to 25n in accordance with the type of the selected article W.

A difference between the rule-based processing unit 23 of the first embodiment and the rule-based processing unit 23B of the second embodiment is that a plurality of image processing algorithms 261 to 26m (m is any integer) are provided. Image processing algorithms 261 to 26m perform different image processing on each other. The rule-based processing unit 23B may perform image processing using all the image processing algorithms 261 to 26m and output determination data D2 based on the image processing result of each of the image processing algorithms 261 to 26m. In addition, the rule-based processing unit 23B may perform the image processing using the image processing algorithms 261 to 26m selected by the operation of the display operation unit 3 or the image processing algorithms 261 to 26m in accordance with to the type of the selected article W, and output the determination data D2 based on the results of the performed image processing.

According to the embodiment described above, the AI processing unit 22B outputs the determination data D1 using the plurality of learning models 251 to 25n. As a result, it is possible to further improve the inspection accuracy.

According to the embodiment described above, the rule-based processing unit 23B outputs the determination data D2 using the plurality of image processing algorithms 261 to 26m. As a result, it is possible to further improve the inspection accuracy.

The present invention is not limited to the above-described embodiment, and can be modified, improved, and the like as appropriate. In addition, the material, shape, dimensions, number, disposition location, and the like of each component in the above-described embodiment are various as long as the present invention can be achieved, and are not limited.

As the learning model 25, in addition to the embodiment described above, it is considered to use a well-known learning model such as deep learning (object extraction, image classification, anomaly detection, and the like) or machine learning (support vector machine, random forest).

### DESCRIPTION OF REFERENCE NUMERALS AND SIGNS

1,1B: article inspection apparatus
3: display operation unit (determination rule setting unit)
11: imaging unit
21: image storage unit
22, 22B: artificial intelligence (AI) processing unit
23, 23B: rule-based processing unit
24, 24B: comprehensive determination unit
25, 251 to 25n: learning model
26, 261 to 26m: image processing algorithm
D1, D2: determination data
W: article

What is claimed is:

1. An article inspection apparatus that inspects an article based on a captured image, the article inspection apparatus comprising:
an image storage unit that stores the captured image of the article captured by an imaging unit;
an AI processing unit that outputs first determination data indicating a quality state of the article captured in the captured image using a learning model that has been trained with an image in advance;
a rule-based processing unit that performs image processing on the captured image using a predetermined image processing algorithm and outputs second determination data indicating the quality state of the article captured in the captured image; and
a comprehensive determination unit that performs comprehensive determination of the quality state of the article captured in the captured image based on the first determination data and the second determination data.

2. The article inspection apparatus according to claim 1,
wherein, in a case where the first determination data and/or the second determination data includes a defect in the quality state of the article, position information of a defective portion in the captured image is further included.

3. The article inspection apparatus according to claim 1, further comprising:
a determination rule setting unit that sets a rule for determination of the comprehensive determination unit,
wherein the comprehensive determination unit performs the comprehensive determination of the quality state in accordance with the set rule.

4. The article inspection apparatus according to claim 2, further comprising:
a determination rule setting unit that sets a rule for determination of the comprehensive determination unit,
wherein the comprehensive determination unit performs the comprehensive determination of the quality state in accordance with the set rule.

5. The article inspection apparatus according to claim 1,
wherein the first determination data and the second determination data each indicate a defect degree for each position of the captured image, and
the comprehensive determination unit synthesizes the first determination data output from the AI processing unit and the second determination data output from the rule-based processing unit, and performs the comprehensive determination of the quality state of the article from a synthesis result.

6. The article inspection apparatus according to claim 2,
wherein the first determination data and the second determination data each indicate a defect degree for each position of the captured image, and
the comprehensive determination unit synthesizes the first determination data output from the AI processing unit and the second determination data output from the rule-based processing unit, and performs the comprehensive determination of the quality state of the article from a synthesis result.

7. The article inspection apparatus according to claim 3,
wherein the first determination data and the second determination data each indicate a defect degree for each position of the captured image, and
the comprehensive determination unit synthesizes the first determination data output from the AI processing unit and the second determination data output from the rule-based processing unit, and performs the comprehensive determination of the quality state of the article from a synthesis result.

8. The article inspection apparatus according to claim 1,
wherein, in a case where a first defective portion is included in the first determination data and a second defective portion different from the first defective portion is included in the second determination data, the comprehensive determination unit determines that both the first defective portion and the second defective portion are defective portions of the article.

9. The article inspection apparatus according to claim 2,
wherein, in a case where a first defective portion is included in the first determination data and a second defective portion different from the first defective portion is included in the second determination data, the comprehensive determination unit determines that both the first defective portion and the second defective portion are defective portions of the article.

10. The article inspection apparatus according to claim 3,
wherein, in a case where a first defective portion is included in the first determination data and a second defective portion different from the first defective portion is included in the second determination data, the comprehensive determination unit determines that both the first defective portion and the second defective portion are defective portions of the article.

11. The article inspection apparatus according to claim 1,
wherein the AI processing unit outputs the first determination data using a plurality of the learning models.

12. The article inspection apparatus according to claim 2,
wherein the AI processing unit outputs the first determination data using a plurality of the learning models.

13. The article inspection apparatus according to claim 1,
wherein the rule-based processing unit performs the image processing on the captured image using a plurality of the image processing algorithms, and outputs the second determination data based on an image processing result of each image processing algorithm.

14. The article inspection apparatus according to claim 2,
wherein the rule-based processing unit performs the image processing on the captured image using a plurality of the image processing algorithms, and outputs the second determination data based on an image processing result of each image processing algorithm.
